(19) United States
(12) Patent Application Publication
(10) Pub. No.: US 2025/0317317 A1
(43) Pub. Date: Oct. 9, 2025

(54) SYSTEMS AND METHODS FOR AUTOMATIC SPEAKER TRACKING FOR VIDEO CONFERENCES BASED ON VOICEPRINT, LIP AND BODY MOTION DETECTION

(71) Applicant: RingCentral, Inc., Belmont, CA (US)

(72) Inventors: Bicang He, Hangzhou City (CN); Chen Wei, Hangzhou (CN)

(21) Appl. No.: 19/095,490

(22) Filed: Mar. 31, 2025

(30) Foreign Application Priority Data
Apr. 9, 2024 (WO) PCT/CN2024/086721

(51) Int. Cl. H04L 12/18; G06V 40/16; H04N 23/58

(52) U.S. Cl. CPC H04L 12/1831; G06V 40/165; H04N 23/58

(57) ABSTRACT

The present disclosure provides methods, systems, and mediums for identifying an active speaker within an online conferencing session. The method comprises the steps of receiving an audio/video stream from a client device during an online conferencing session. Upon a participant speaking: identifying, a voiceprint representing the participant, wherein the voiceprint represents one or more unique vocal characteristics of the participant. Detecting a spatial position of the participant based upon movement of one or more markers of interest on the first speaker. Generating a mapping between the voiceprint and the spatial position of the participant. Using the voiceprint and the spatial position of the participant to identify the participant as a first active speaker. The method further comprises generating instructions to adjust positioning of a camera so that the first active speaker is centered within a video stream.

### RELATED APPLICATION

The instant application claims the benefit and priority to Application Number PCT/CN2024/086721, filed on Apr. 9, 2024, which is incorporated by reference in its entirety.

### TECHNICAL FIELD

The present disclosure relates generally to the field of computer-supported meetings/conferences. More specifically, and without limitation, this disclosure relates to systems and methods for automatically tracking a speaker in a video conference based on the speaker's voiceprint and motion detection.

### BACKGROUND

Video conferencing has become an essential tool for conducting meetings with participants, some that are co-located (for example, in a conference room), and some that may be located in different physical locations. Advances in video conferencing software have enabled software to dynamically switch video streams based on which speaker is actively speaking. For example, when a first participant in one location begins speaking, the video conferencing software may be implemented to automatically show video for the first participant when they begin to speak. Additionally, if a second participant, in another location, begins to speak the video conferencing software may automatically switch to show video of the second participant speaking. The feature of automatically switching a video feed to the active speaker allows other participants to stay engaged and follow the conversation both auditorily and visually.

However, determining which speaker co-located with other participants in a video conference is actively speaking may become challenging when the active speaker is not directly speaking into the camera or when multiple speakers are engaging at the same time. To overcome this, conventional approaches may implement a microphone array for each conference room. Microphone arrays include a set of multiple microphones arranged in a specific pattern to capture audio in a location. The microphone array may calculate an audio source's location by estimating time lags between audio capture from each microphone. The differences in audio recordings from each microphone are used to determine a precise location of the audio source within the room. However, the main drawback to using a microphone array is the large monetary cost for the equipment and the extensive calibration needed to accurately set up the microphone array.

Other solutions may implement technique for identifying an active speaker using video streams. For instance, some solutions may implement motion detection and/or lip movement detection to determine when a person is speaking. However, solely relying on motion and/or lip detection may not yield accurate results when a speaker is not looking directly at the camera. For instance, an active speaker may be speaking while looking at his notes. A motion and/or lip detection system may not detect movement of a speaker's lips when the speaker is not looking at the camera. Thus, systems and methods are desired that more accurately identify an active speaker than what is currently available.

### SUMMARY

The appended claims may serve as a summary of the invention.

### BRIEF DESCRIPTION OF THE DRAWINGS

The accompanying drawings, which comprise a part of this specification, illustrate several embodiments and, together with the description, serve to explain the principles disclosed herein. In the drawings:

FIG. 1 depicts a diagram of a communication system suitable for realization of one of the embodiments of a conferencing platform, according to the present disclosure.

FIG. 2 depicts an illustration of the conferencing server, according to an embodiment.

FIG. 3 is a diagram of a user device for use in a communication system, according to an embodiment.

FIG. 4A depicts an example video frame from a video conference in which multiple persons are displayed, according to an embodiment.

FIG. 4B depicts an example of an adjusted video feed where the active speaker is centered within the video, according to the present disclosure.

FIG. 5 depicts a flowchart for identifying an active speaker in an online conferencing session and generating instructions to adjust a camera to focus on the active speaker, according to an embodiment.

FIG. 6 depicts another flowchart for identifying an active speaker in an online conferencing session, caching spatial positioning information for speakers, and generating instructions to adjust a camera to focus on the active speaker, according to an embodiment.

### DETAILED DESCRIPTION

Before various example embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing concepts, and the terminology is not intended to be limiting. Unless defined otherwise, all technical and scientific terms used herein have the same meaning as commonly understood by those skilled in the art to which the embodiment pertains.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the detailed descriptions that follow are presented in terms of procedures, methods, flows, logic blocks, processing, and other symbolic representations of operations performed on a computing device or a server. These descriptions are the means used by those skilled in the arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical, optical, or magnetic signals capable of being stored, transferred, combined, compared, and otherwise manipulated in a computer system or computing device or a processor. These signals are sometimes referred to as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “forming,” “detecting,” “processing,” “updating,” “instantiating,” “identifying”, “contacting”, “gathering”, “accessing”, “utilizing”, “resolving”, “applying”, “displaying”, “requesting”, “monitoring”, “changing”, “updating”, “establishing”, “initiating”, or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

A “computer” is one or more physical computers, virtual computers, and/or computing devices. As an example, a computer can be one or more server computers, cloud-based computers, cloud-based cluster of computers, virtual machine instances or virtual machine computing elements such as virtual processors, storage and memory, data centers, storage devices, desktop computers, laptop computers, mobile devices, Internet of Things (IoT) devices such as home appliances, physical devices, vehicles, and industrial equipment, computer network devices such as gateways, modems, routers, access points, switches, hubs, firewalls, and/or any other special-purpose computing devices. Any reference to “a computer” herein means one or more computers, unless expressly stated otherwise.

The “instructions” are executable instructions and comprise one or more executable files or programs that have been compiled or otherwise built based upon source code prepared in JAVA, C++, OBJECTIVE-C, or any other suitable programming environment.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

Computer storage media can include volatile and nonvolatile, removable, and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, solid state drives, hard drives, hybrid drive, or any other medium that can be used to store the desired information and that can be accessed to retrieve that information.

It is appreciated that present systems and methods can be implemented in a variety of architectures and configurations. For example, present systems and methods can be implemented as part of a distributed computing environment, a cloud computing environment, a client server environment, hard drive, etc. Example embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments.

It should be understood that terms “user” and “participant” have equal meaning in the following description.

Embodiments are described in sections according to the following outline:
1.0 GENERAL OVERVIEW
2.0 STRUCTURAL OVERVIEW
3.0 FUNCTIONAL OVERVIEW
4.0 PROCEDURAL OVERVIEW

### 1.0 General Overview

The current disclosure provides a technical solution to the technological problem of locating an active speaker in a video conferencing session using a camera and a single microphone. Generally, a conferencing system allows users to share their video feed in a group setting with other groups in other conference rooms during the video conferencing session. In some cases, where there are multiple participants in a conference room, it is desirable to locate the active speaker in the conference room and focus the camera on the active speaker such that the active speaker is the focus for the video feed distributed to other participants.

The current disclosure solves the problem of identifying the active speaker and making the active speaker the focus of the video feed by identifying vocal characteristics for each speaker and then determining a particular speaker as an active speaker by matching their vocal characteristics and detecting spatial movement that indicates a person is speaking. In one aspect of the present disclosure, a computer-implemented method for identifying an active speaker is disclosed. The computer-implemented method comprises the steps of receiving an audio stream and video stream from a client device during an online conferencing session in which multiple participants are co-located in a conference. The audio and video stream contains an audio clip and a set of video frames. Upon detecting a participant, of multiple participants, speaking: identifying, from the audio and video stream, a voiceprint representing the participant, wherein the voiceprint represents one or more unique vocal characteristics of the participant; detecting, from the audio and video stream, a spatial position of the participant based upon movement of one or more markers of interest on the first speaker. The method further comprises generating a mapping between the voiceprint and the spatial position of the participant. The method further comprises, using the voiceprint and the spatial position of the participant to identify the participant as a first active speaker. Therefore, the current solution provides a technological benefit of identifying the active speaker, within a video stream, using a single camera and captured audio.

In one embodiment of the present disclosure, further comprises, generating instructions to adjust positioning of a camera so that the first active speaker is centered within a video frame produced by the camera.

In one embodiment, the present disclosure wherein identifying the voiceprint representing the participant comprises, using a trained machine learning model to identify the voiceprint of the participant, wherein the trained machine model is configured to receive, as input the audio stream, and identify vocal characteristics of the participant.

Another example embodiment of the present disclosure, further comprises upon identifying the voiceprint representing the participant, generating a hash ID containing binary representations of the one or more unique vocal characteristics that make up the voiceprint.

In another embodiment, the one or more markers of interest on the first speaker comprises points on a lip of the first speaker. In yet another example embodiment, the one or more markers of interest on the first speaker comprises points on the first speaker's body and face.

In another embodiment, the method further comprises upon detecting the spatial position of the participant, determining a bounding box within the video stream that contains the participant based on the spatial position.

In another embodiment, generating the mapping between the voiceprint and the spatial position of the participant, further comprises, storing the association between the voiceprint and the spatial position in a cache.

In another embodiment, the method further comprises receiving a second audio stream and a second video stream, the second audio stream includes a second portion of audio and the second video stream includes and a second set of video frames; upon the participant speaking: identifying, from the second audio stream, the voiceprint representing the participant; determining whether the voiceprint representing the participant is stored in the cache; upon determining that the voiceprint representing the participant is stored in the cache, retrieving the mapping between the voiceprint and the spatial position of the participant; using the mapping between the voiceprint and the spatial position of the participant, retrieved from the cache, to generate second instructions to adjust positioning of the camera so that the participant is centered within the video stream produced by the camera.

In another embodiment, the method further comprises upon determining that the voiceprint representing the participant is stored in the cache, determining whether the mapping is valid based an associated timestamp of when the mapping was generated; upon determining that the mapping of the participant is not valid: detecting, from the second video stream, a second spatial position of the participant based upon movement of the one or more markers of interest on the first speaker; updating the mapping between the voiceprint and the second spatial position of the participant to reflect a new position of the participant.

In another embodiment, the method further comprises monitoring one or more mappings between voiceprints of speakers and their corresponding spatial positions stored in the cache; determining whether a particular mapping of the one or more mappings is still valid; upon determining that the particular mapping is not valid, updating the particular mapping with an updated spatial position for a particular speaker associated with the particular association.

According to a second aspect of the present disclosure, a system for identifying an active speaker within an online conferencing session is proposed. The system comprises a processor; and a memory storing instructions that, when executed by the processor, causes: receiving an audio stream and video stream from a client device during an online conferencing session in which multiple participants are co-located in a conference room; upon detecting a participant, of the multiple participants, speaking: identifying, from the audio and video stream, a voiceprint representing the participant, wherein the voiceprint represents one or more unique vocal characteristics of the participant; detecting, from the audio and video stream, a spatial position of the participant based upon movement of one or more markers of interest on the first speaker; generating a mapping between the voiceprint and the spatial position of the participant; and using the voiceprint and the spatial position of the participant to identify the participant as the first active speaker.

According to a third aspect of the present disclosure, a non-transitory, computer-readable medium identifying an active speaker within an online conferencing session is proposed. The medium stores a set of instructions that, when executed by a processor, cause the following: receiving an audio stream and video stream from a client device during an online conferencing session in which multiple participants are co-located in a conference room; upon detecting a participant, of the multiple participants, speaking: identifying, from the audio and video stream, a voiceprint representing the participant, wherein the voiceprint represents one or more unique vocal characteristics of the participant; detecting, from the audio and video stream, a spatial position of the participant based upon movement of one or more markers of interest on the first speaker; generating a mapping between the voiceprint and the spatial position of the participant; and using the voiceprint and the spatial position of the participant to identify the participant as the first active speaker. Therefore, the current solution provides a technological benefit of identifying the active speaker, within a video stream, using a single camera and captured audio.

### 2.0 Structural Overview

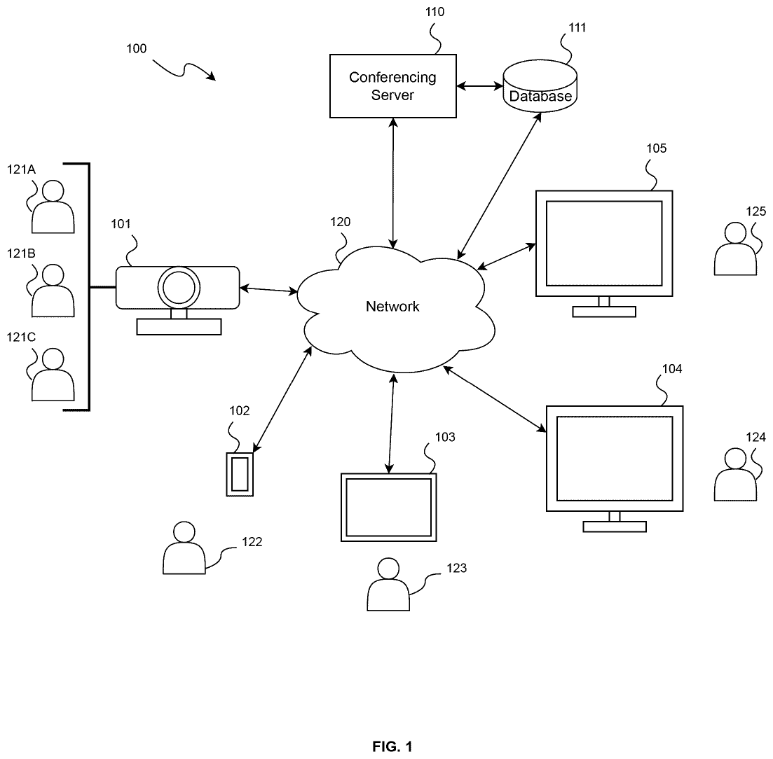

FIG. 1 depicts a diagram of a communication system suitable for realization of one of the embodiments of a conferencing platform, according to the present disclosure. The communication system 100 facilitates communications between user devices 101, 102, 103, 104, and 105, each associated with one or more corresponding users 121A, 121B, 121C, 122, 123, 124 and 125, a conferencing server 110, and a database 111. Network 120 may be any type of network that provides communications or facilitates the exchange of information between the conferencing server 110 and user devices 101, 102, 103, 104, and 105. For example, network 120 broadly represents one or more local area networks (LANs), wide area networks (WANs), metropolitan area networks (MANs), global interconnected internetworks, such as the public internet, or other suitable connection(s) or combination thereof that enables communication system 100 to send and receive information between the user devices 101, 102, 103, 104, and 105 and the conferencing server 110. Each such network 120 uses or executes stored programs that implement internetworking protocols according to standards such as the Open Systems Interconnect (OSI) multi-layer networking model, including but not limited to Transmission Control Protocol (TCP) or User Datagram Protocol (UDP), Internet Protocol (IP), Hypertext Transfer Protocol (HTTP), and so forth. All computers described herein are configured to connect to the network 120 and the disclosure presumes that all elements of FIG. 1 are communicatively coupled via network 120. A network may support a variety of electronic messaging formats and may further support a variety of services and applications for user devices 101, 102, 103, 104, and 105.

User device 101 may represent a combination of specific video conferencing hardware that includes an adjustable video conference camera, microphone, and projection screen, or any other combination. As depicted in FIG. 1, user device 101 is associated with a group of users, user 121A, user 121B, and user 121C, that are co-located in the same conference room. The other user devices may include, but are not limited to, a desktop user device 104 and 105 executing any known operational environment, e.g., Windows®, MacOS®, Linux® or Unix®. At the same time, other user devices may be mobile telephones, such as smartphone devices, e.g., user device 102, or tablets, e.g., user device 103, executing any of the known operational environments, e.g., Android® or iOS.

In accordance with the present disclosure, user devices 101, 102, 103, 104 and 105 are programmed to send and receive audio and video streams to and from the conferencing server 110 via network 120.

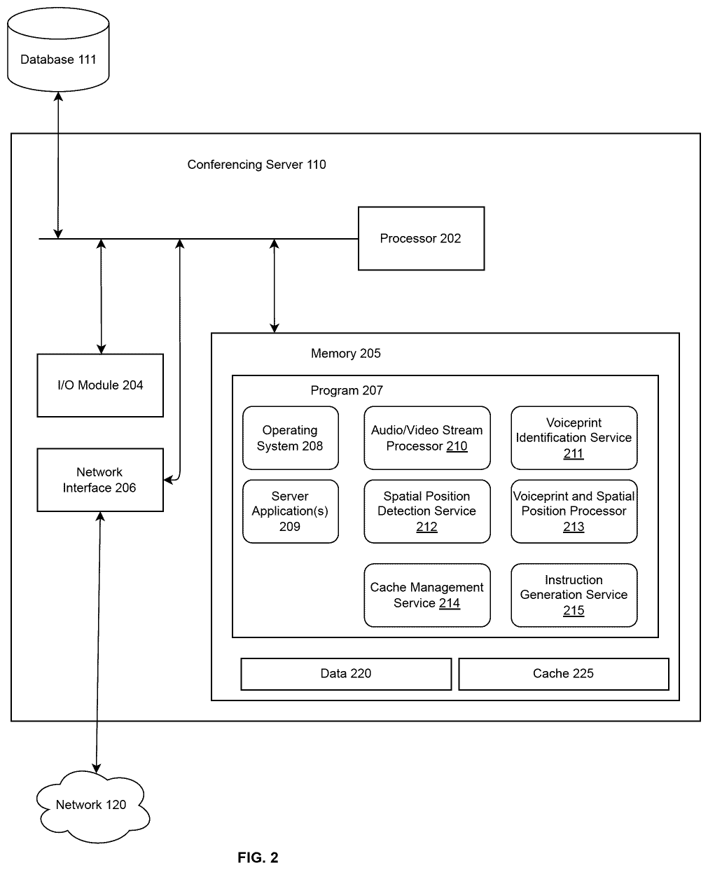

FIG. 2 depicts an illustration of the conferencing server 110, according to an embodiment. The conferencing server 110 may include at least one processor, e.g., processor 202. The processor 202 may be operably connected to one or more databases (e.g., database 111), an input/output (I/O) module 204, memory 205, and network interface device 206.

I/O module 204 may be operably connected to a keyboard, mouse, touch screen controller, and/or other input controller(s) (not shown). Other input/control devices connected to I/O module 204 may include one or more touchpads, trackballs, buttons, rocker switches, thumbwheel, infrared port, USB port, and/or a pointer device such as a stylus.

Processor 202 may also be operably connected to memory 205. Memory 205 may include high-speed random-access memory and/or non-volatile memory, such as one or more magnetic disk storage devices, one or more optical storage devices, and/or flash memory (e.g., using NAND, NOR gates).

Memory 205 may include one or more programs 207. For example, memory 205 may store an operating system 208, such as DARWIN, RTXC, Linux®, iOS, Unix®, OS X, Windows®, or an embedded operating system such as VXWorks®. Operating system 208 may include instructions for handling basic system services and for performing hardware dependent tasks. In some implementations, operating system 208 may comprise a kernel (e.g., UNIX kernel).

Memory 205 may also store one or more server applications 209 to facilitate communicating with one or more additional devices, one or more computers and/or one or more servers. Server applications 209 may also include instructions to execute one or more of the disclosed methods. Memory 205 may also include cache 225. Cache 225 may represent a dedicated area, within memory 205, configured to store conference-related data. Examples of conference-related data may include, but are not limited to, voiceprint data associated with participants, spatial positioning data associated with participants, audio data, video data, and any other data related to participants, conference rooms, client devices, and scheduled conferences. Memory 205 may also store data 210. Data 210 may include transitory data used during instruction execution. Data 210 may also include data recorded for long-term storage.

In an embodiment, programs 207 may include an audio and video stream processor 210, a voiceprint identification service 211, a spatial position detection service 212, data management service 213, and an instruction generation service 214. In yet other embodiments, programs 207 may include more or fewer services than what is depicted in FIG. 2.

In an embodiment, the audio and video stream processor 210 is configured to receive video data, in the form of video streams, from one of more user devices 101-105 and write the video data into cache 225 of memory 205. The video stream may represent video captured using a video capture device communicatively coupled to user device 101. The video capture device may include, but is not limited to, a camera device integrated into user device 101 and an external camera device communicatively coupled to user device 101, such as an external wired camera as well as an external wireless camera. In an embodiment, the audio and video stream processor 210 may implement one or more computer processes to write the video data to the cache 225 as video is being captured in real-time. For example, an integrated camera on user device 101 captures video data of a participant engaged in a video conference session. The integrated camera may send the captured video data to the audio and video stream processor 210. The audio and video stream processor 210 may invoke a process configured to write the received video data to the cache 225 as the video is received.

In an embodiment, the audio and video stream processor 210 is additionally configured to receive audio data, in the form of audio streams, from one of more user devices 101-105 and write the audio data into cache 225. The audio stream may represent audio captured using an audio capture device communicatively coupled to user device 101. The audio capture device may include, but is not limited to, a microphone integrated into user device 101 and an external microphone communicatively coupled to user device 101, such as an external wired microphone mounted in a conference room. In an embodiment, the audio and video stream processor 210 may implement one or more computer processes to write the audio data to the cache 225 as audio is being captured in real-time.

In an embodiment, the voiceprint identification service 211 is configured to identify a voice signature or vocal biometric for speakers in a conference. The voiceprint identification service 211 may retrieve audio data stored in the cache 225 and analyze the audio data to determine specific vocal characteristics of a person speaking during the conference. The voiceprint identification service 211 may analyze elements of a person's speech, such as their pitch, tone, rhythm, and pronunciation of words and phrases, to identify a unique speech pattern that distinguishes one person's voice from another person's voice. Upon determining the unique speech characteristics of a person's speech, the voiceprint identification service 211 generates a HASH ID representing the unique speech characteristics of a person's speech in binary form.

In an embodiment, the voiceprint identification service 211 may implement a trained machine learning model to analyze and identify the unique characteristics of a person's speech from audio samples captured by a user device 101. For example, the voiceprint identification service 211 may implement a trained machine learning model that receives, as input, an audio sample of a person speaking. Output of the trained machine learning model may be a binary representation of speech characteristics of the speaker. The voiceprint identification service 211 may then generate a HASH ID for the speech characteristics. The machine learning model may be implemented using one or more of: Artificial Neural Networks (ANN), Deep Neural Networks (DNN), XLNet for Natural Language Processing (NLP), General Language Understanding Evaluation (GLUE), Word2Vec, Convolution Neural Networks (CNN), Long Short-Term Memory (LSTM) networks, Gated Recurrent Unit (GRU) networks, Hierarchical Attention Networks (HAN), or any other type of machine learning model. The machine learning models listed herein serve as examples and are not intended to be limiting. In other embodiments, the voiceprint identification service 211 may implement any other algorithm configured to identify speech characteristics from an audio sample.

In an embodiment, the spatial position detection service 212 is configured to identify a spatial position of one or more markers associated with a participant that is actively speaking within one or more video frames. The spatial position detection service 212 may retrieve one or more video frames stored in the cache 225 by the audio and video stream processor 210. It should be noted that the one or more video frames may be stored within a cache queue in the cache 225. For example, the cache 225 may implement a cache queue for temporarily storing video frames received in real-time. Upon retrieving the one or more video frames, the spatial position detection service 212 analyzes the one or more video frames to determine one or more persons within the video frames. After detecting one or more persons, the spatial position detection service 212, for each person detected, identifies markers of interest for each person. For example, a set of lip markers of interest may include several points on a person's lips. By analyzing movement of the set of lip markers of interest, the spatial position detection service 212 may determine when the person is moving their lips. The spatial position detection service 212 may assign a confidence score to each person, where the confidence score represents a level of confidence that the person identified is actively speaking. For example, if a person's lips are not moving, then the spatial position detection service 212 may assign a low confidence score such as 0% or 5% confidence that the person is speaking. However, if the person is moving their lips in a manner consistent with an active speaker, the spatial position detection service 212 may assign a high confidence score such as 90% or 100%. For other cases in which a person is yawning or otherwise moving parts of their lips, the spatial position detection service 212 may assign a slightly higher confidence score such as 50%. The spatial position detection service 212 calculates the confidence score based on how a person's lips move and whether the movement is typically associated with speaking.

Additionally, the spatial position detection service 212 may identify several points on the persons face and body. These points may be used in conjunction with the set of lip markers of interest to determine when a person is speaking. For instance, changes in position of the lip markers of interest over a series of video frames may indicate a person is talking. Additionally, the changes in position of the lip markers of interest may be compared to changes in position of points on the persons face and body over a series of video frames to determine whether a person is talking or simply moving around in the video frame. In another example, the spatial position detection service 212 may analyze markers of interest on the body, such as hands and arms, to determine whether a person is actively speaking. For example, spatial position detection service 212 may take into account movement of a person's arms and hands, in combination with their lip movements, to determine that the person is the active speaker. That is, the movement of the person's arms and hands may, in combination with their lip movements, increase the confidence score assigned to the person.

The spatial position detection service 212 may use other markers on the persons face and/or body to determine a bounding box around the person within the video frame. The bounding box may be used to locate the person's lips and the set of lip markers of interest. Additionally, the bounding box may be used to center a video on the person who is speaking. For example, if person A is speaking, the bounding box used to identify person A may also be used to adjust a camera in a conference room such that person A is in focus and is the center of the video frame.

In an embodiment, the spatial position detection service 212 may analyze multiple video frames to reduce positioning errors. For example, if video frame X is corrupted or does not show person A, even though person A is in other video frames, the spatial position detection service 212 may evaluate the position of person A in prior and subsequent video frames to video frame X to determine whether video frame X is erroneous.

In an embodiment, the spatial position detection service 212 may implement a trained machine learning model to analyze one or more video frames and identify a person speaking within the video frames. For example, the spatial position detection service 212 may implement a trained machine learning model that receives, as input, a one or more video frames of a person speaking. Output of the trained machine learning model may be a set of spatial positions that identify a bounding box that includes the person speaking, a set of spatial positions identifying a person's lip and face, and the confidence score representing the accuracy of the prediction. The machine learning model may be implemented using one or more of: Artificial Neural Networks (ANN), Deep Neural Networks (DNN), XLNet for Natural Language Processing (NLP), General Language Understanding Evaluation (GLUE), Word2Vec, Convolution Neural Networks (CNN), Long Short-Term Memory (LSTM) networks, Gated Recurrent Unit (GRU) networks, Hierarchical Attention Networks (HAN), or any other type of machine learning model. The machine learning models listed herein serve as examples and are not intended to be limiting.

In an embodiment, the data management service 213 is configured to create a mapping between a voiceprint HASH ID for a person and their spatial positioning within video frames. For example, the data management service 213 may receive, for person A, a HASH ID representing person A's speech characteristics identified by the voiceprint identification service 211. The data management service 213 may also receive a set of spatial positions representing the spatial position of person A's body, face, and lips. The data management service 211 may generate a mapping that maps person A's HASH ID to their spatial position within the video frames. The data management service 213 may store the mapping in cache 225. Additionally, the mapping may also contain a timestamp that may be used to determine whether the mapping is still valid. For example, after a period of time person A may move around within a conference room and as a result the HASH ID-to-spatial position mapping may be out of date. The data management service 213 may monitor timestamps for HASH ID-to-spatial position mappings and if mappings are older than a specific period of time, the data management service 213 may instruct the spatial position detection service 212 to reevaluate the spatial positioning of person A.

In an embodiment, the instruction generation service 214 is implemented to generate positioning instructions for a video camera in a conference room based on the determined location of a speaker. For example, upon determining the voiceprint and spatial position of the speaker, the data management service 213 provides the spatial positioning for the active speaker to the instruction generation service 213. The instruction generation service 214 may format the spatial positioning information into camera coordinates and may send the updated camera coordinates to the user device 101 implemented in the conference room where the active speaker is located. The camera coordinates are used by the user device 101 to position the camera such that the active speaker, or a feature of the active speaker such as the active speaker's face or the active speaker's lips, is the focal point of the video feed. For example, the camera coordinates may be used by the user device 101 to position the camera such that the active speaker's face is positioned in the center of the video feed.

Each of the above identified instructions and applications may correspond to a set of instructions for performing one or more functions described above. These instructions could be implemented as separate software programs, procedures, or modules. Memory 205 may include additional instructions or fewer instructions. Furthermore, various functions of conferencing server 110 may be implemented in hardware and/or in software, including in one or more signal processing and/or application specific integrated circuits.

Communication functions may be facilitated through one or more network interfaces for example the network interface 206 in the presently described example embodiment. Network interface 206 may be configured for communications over Ethernet, radio frequency, and/or optical (e.g., infrared) frequencies. The specific design and implementation of network interface 206 depends on the communication network(s) over which conferencing server 110 is intended to operate. For example, in some embodiments, conferencing server 110 includes wireless/wired network interface 206 designed to operate over a GSM network, a GPRS network, an EDGE network, a Wi-Fi® or WiMax® network, and a Bluetooth® network. In other embodiments, conferencing server 110 includes wireless/wired network interface 206 designed to operate over a TCP/IP network. Accordingly, network 120 may be any appropriate computer network compatible with network interface 206.

The various components in conferencing server 110 may be coupled by one or more communication buses or signal lines (not shown).

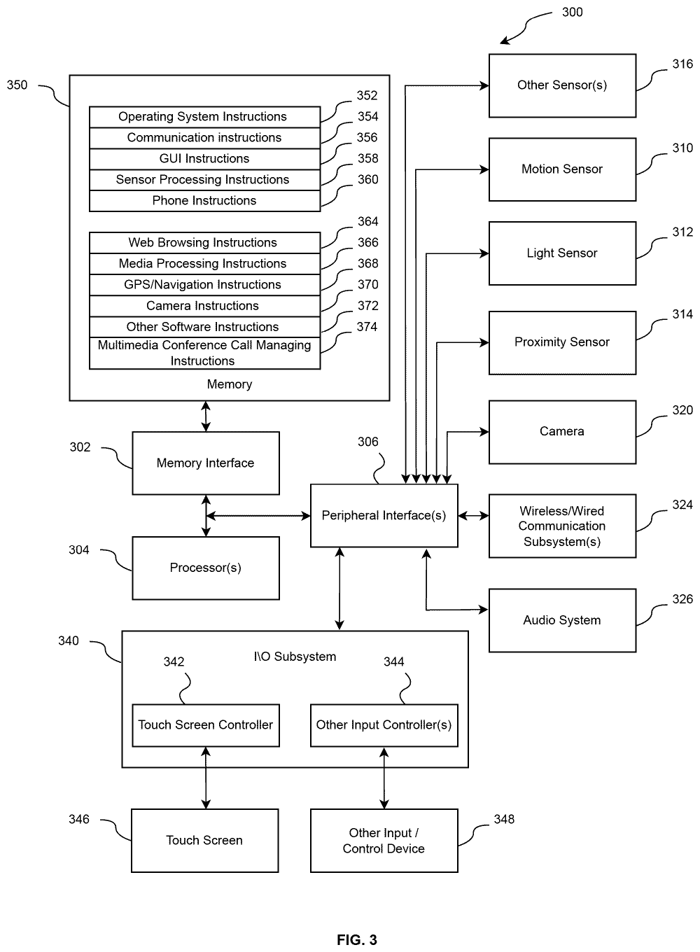

FIG. 3 is a diagram of a user device 300 for use in a communication system, such as communication system 100. The user device 300 can be used to implement computer programs, applications, methods, processes, or other software to perform embodiments described in the present disclosure, such as the user devices 102, 104, 106, and 108. The user device 300 includes a memory interface 302, a peripheral interface 306, one or more processors 304 such as data processors, image processors and/or central processing units. a peripheral interface 306. The memory interface 302, the one or more processors 304, and/or the peripheral interface 306 can be separate components or can be integrated in one or more integrated circuits. The various components in the user device 300 can be coupled by one or more communication buses or signal lines.

Sensors, devices, and subsystems can be coupled to the peripherals interface 306 to facilitate multiple functionalities. For example, a motion sensor 310, a light sensor 312, and a proximity sensor 314 can be coupled to the peripherals interface 206 to facilitate orientation, lighting, and proximity functions. Other sensors 316 can also be connected to the peripherals interface 306, such as a positioning system (e.g., GPS receiver), a temperature sensor, a biometric sensor, or other sensing device, to facilitate related functionalities. A GPS receiver can be integrated with, or connected to, the user device 300. For example, a GPS receiver can be built into mobile telephones, such as smartphone devices, e.g., user device 104, or into laptop, e.g., user device 106. GPS software allows mobile telephones to use an internal or external GPS receiver (e.g., connecting via a serial port or Bluetooth®). A camera 320 and an optical sensor 322, e.g., a charged coupled device (“CCD”) or a complementary metal-oxide semiconductor (“CMOS”) optical sensor, may be utilized to facilitate camera functions, such as recording photographs and video clips.

Communication functions may be facilitated through one or more wireless/wired communication subsystems 324, which includes an Ethernet port, radio frequency receivers and transmitters and/or optical (e.g., infrared) receivers and transmitters. The specific design and implementation of the wireless/wired communication subsystem 324 depends on the communication network(s) over which the user device 300 is intended to operate. For example, in some embodiments, the user device 300 includes wireless/wired communication subsystems 324 designed to operate over a GSM network, a GPRS network, an EDGE network, a Wi-Fi® or WiMax® network, and a Bluetooth® network.

An audio system 326 may be used to facilitate voice-enabled functions, such as voice recognition, voice replication, digital recording, and telephony functions.

The I/O subsystem 340 includes a touch screen controller 342 and/or other input controller(s) 344. The touch screen controller 342 is coupled to a touch screen 346. The touch screen 346 and touch screen controller 342 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 346. While a touch screen 346 is shown in FIG. 3, the I/O subsystem 340 may include a display screen (e.g., CRT or LCD) in place of the touch screen 346.

The other input controller(s) 344 is coupled to other input/control devices 348, such as one or more buttons, rocker switches, thumbwheel, infrared port, USB port, and/or a pointer device such as a stylus. The touch screen 346 can, for example, also be used to implement virtual or soft buttons and/or a keyboard.

The memory interface 302 is coupled to memory 350. The memory 350 includes high-speed random-access memory and/or non-volatile memory, such as one or more magnetic disk storage devices, one or more optical storage devices, and/or flash memory (e.g., NAND, NOR). The memory 350 stores an operating system 352, such as DARWIN, RTXC, Linux®, iOS, Unix®, OS X, Windows®, or an embedded operating system such as VXWorks®. The operating system 352 can include instructions for handling basic system services and for performing hardware dependent tasks. In some implementations, the operating system 352 can be a kernel (e.g., UNIX kernel).

The memory 350 may also store communication instructions 354 to facilitate communicating with one or more additional devices, one or more computers and/or one or more servers. The memory 350 can include graphical user interface instructions to facilitate graphic user interface processing; sensor processing instructions to facilitate sensor-related processing and functions; phone instructions to facilitate phone-related processes and functions; electronic messaging instructions to facilitate electronic-messaging related processes and functions; web browsing instructions to facilitate web browsing-related processes and functions; media processing instructions to facilitate media processing-related processes and functions; GPS/navigation instructions to facilitate GPS and navigation-related processes and instructions; camera instructions to facilitate camera-related processes and functions; and/or other software instructions to facilitate other processes and functions. The memory 350 may also include multimedia conference call managing instructions to facilitate conference call related processes and instructions.

In some embodiments, the communication instructions 354 represent or include software applications to facilitate connection with the conferencing server 110 of FIG. 1 that connects a plurality of user devices. The graphical user interface instructions 356 may include a software program that facilitates display of the communication notifications to a user associated with the user device and facilitates the user to provide user input, and so on.

In an embodiment, camera instructions 370 represent or include software applications to adjust the position of the camera 320. For example, user device 300 may receive, from the instruction generation service 214, instructions to move the positioning of camera 320 such that the active speaker is either in focus or in the center of the captured video.

In the presently described embodiment, the instructions cause the processor 304 to perform one or more functions of the disclosed methods. For example, the instructions may cause the displaying of notifications, the sending of information to the conferencing server 110 or the receiving of information from the conferencing server 110.

Each of the above identified instructions and software applications may correspond to a set of instructions for performing one or more functions described above. These instructions may be implemented as separate software programs, procedures, or modules. The memory 350 may include additional instructions or fewer instructions. Furthermore, various functions of the user device 300 may be implemented in hardware and/or in software, including in one or more signal processing and/or application specific integrated circuits.

The user device 300 of FIG. 3 or the user devices 101, 102, 103, 104, and 105 of FIG. 1 may execute various applications stored in memory 350. For the sake of the present disclosure, the memory 350 of the user device 300 may store a conferencing application of a conferencing platform which, when executed by the processor 202, instructs the user device to communicate with the conferencing server 110 or other user devices 101, 102, 103, 104, and 105 via the network 120 of FIG. 1. In an embodiment, the conferencing application may be a browser-based application being part of the conferencing platform. In another embodiment, the conferencing application may be an application that uses Web Real-Time Communication (WebRTC).

### 3.0 Functional Overview

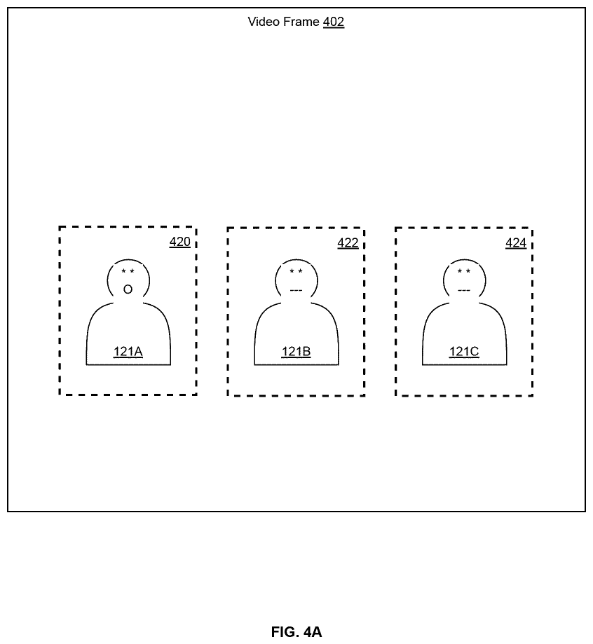

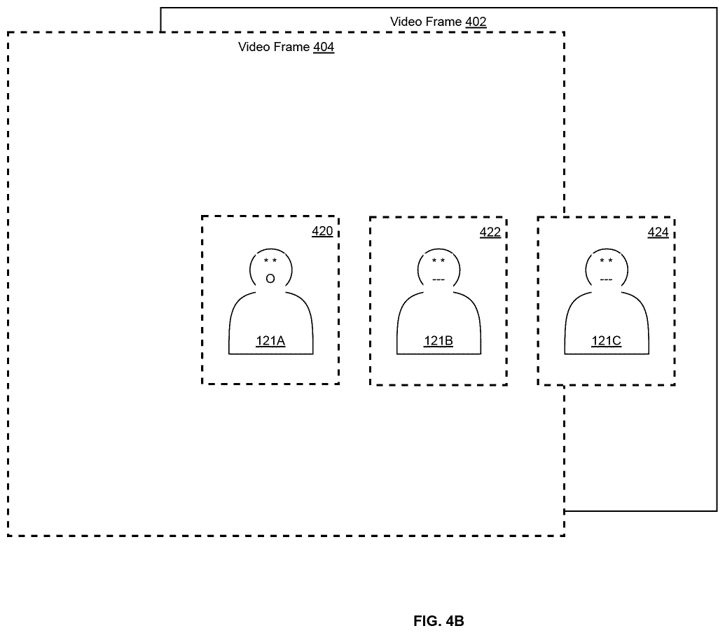

FIG. 4A depicts an example video frame from a video conference in which multiple persons are displayed. FIG. 4A may represent a captured video frame from user device 101. The video frame 402 may be processed by the audio and video stream processor 210 and the video frame 402 may be stored within cache 225. The spatial position detection service 212 may identify three co-located participants in the video frame 402. The spatial position detection service 212 may identify bounding boxes based on the detecting the head, body, and lips of each co-located participant in a video conference. For example, user 121A may be identified as the active speaker and the spatial position detection service 212 may determine bounding box 420 for user 121A. The bounding box 420 may be used to reposition the camera within the conference room so that bounding box 420 is centered in the video. The spatial position detection service 212 may also identify user 121B and user 121C within the video frame and may determine bounding boxes 422 and 424 respectively.

FIG. 4B depicts an example of an adjusted video feed where the active speaker is centered within the video. Referring to FIG. 4B, video frame 404 has been shifted so that the active speaker, user 121A, is centered within video frame 404. By centering the active speaker within the video, other remote participants may be able to more easily follow along as the active speaker is the focus of the video. In other embodiments, the video feed may be adjusted for the active speaker by zooming in so that the active speaker, user 121A, is centered within the video. In yet other embodiments, the video feed may be adjusted so that the active speaker, user 121A, is always in focus.

### 4.0 Procedural Overview

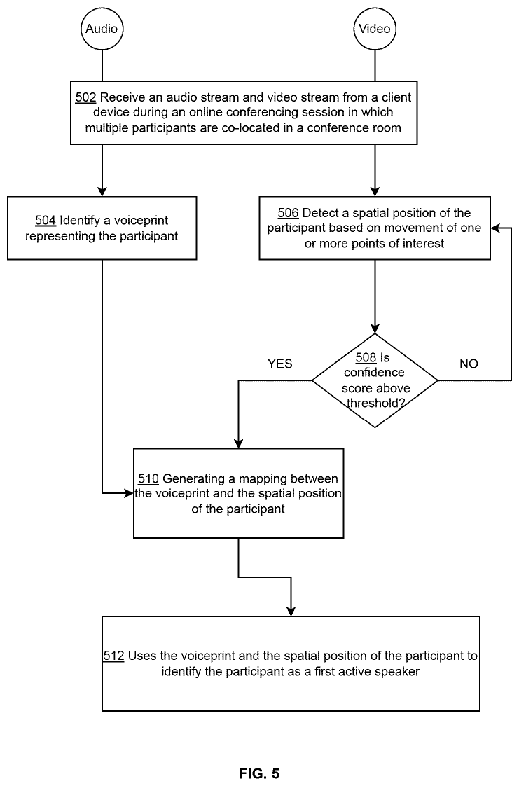

FIG. 5 depicts a flowchart for identifying an active speaker in an online conferencing session and generating instructions to adjust a camera to focus on the active speaker, according to an embodiment. Process 500 may be performed by a single program or multiple programs. The steps of the process as shown in FIG. 5 may be implemented using processor-executable instructions that are stored in computer memory. For the purposes of providing a clear example, the steps of FIG. 5 are described as being performed by computer programs executing on either conferencing server 110 or user device 300. For the purposes of clarity, process 500 is described in terms of a single entity.

At step 502, process 500 receives an audio stream and a video stream from a client device during an online conferencing session in which multiple participants are co-located in a conference room. In an embodiment, the audio and video stream processor 210 may receive an audio stream and a video stream from user device 101, which may represent hardware in a conference room with multiple participants. The audio and video stream processor 210 may separate the audio and video stream, may store the video frames in a video frame cache queue on cache 225, may store the audio in an audio cache queue on cache 225.

At step 504, process 500 identifies a voiceprint representing the participant. In an embodiment, the voiceprint identification service 211 retrieves audio data from the cache queue in cache 225 and analyzes the audio data to determine specific vocal characteristics of user 121A speaking during the online conferencing session. Upon determining unique speech characteristics for user 121A, the voiceprint identification service 211 generates a HASH ID representing the unique speech characteristics of user 121A′s speech. The HASH ID may be stored in cache 225.

At step 506, process 500 detects a spatial position of the participant based on movement of one or more markers of interest of the first speaker. Steps 504 and 506 may occur in parallel. In an embodiment, the spatial position detection service 212 retrieves one or more video frames stored in the cache 225. The spatial position detection service 212 analyzes the one or more video frames to determine the participant is speaking and determine the participant's spatial position. In an embodiment, the spatial position detection service 212 assigns a confidence score to each person detected in the one or more video frames. For example, spatial position detection service 212 assigns a confidence score representing a level of confidence that the person identified is actively speaking. For example, referring to FIG. 4A, the spatial position detection service 212 may assign a confidence score of 80% to user 121A because user 121A's lips are moving. The spatial position detection service 212 may assign a confidence score of 20% to user 121B because user 121B's lips were moving slightly. The spatial position detection service 212 may assign a confidence score of 0% to user 121C because user 121C's lips are not moving.

At decision diamond 508, process 500 determines whether the confidence score is above a threshold. In an embodiment, the data mapping service 213 may evaluate whether the confidence score is above a minimum threshold for identifying an active speaker based on lip movement. In some embodiments, the threshold may be automatically determined based on historical data from prior video conferences. Alternatively, the threshold may be manually configured by a conference session engineer or any other user. For example, the minimum threshold may be set at 75%. If the data mapping service 213 determines that the confidence score for user 121A (confidence score of 80%) is above the minimum threshold, then process 500 proceeds to step 510. If, however, the data mapping service 213 determines that the confidence score for user 121A is below the minimum threshold, then process 500 proceeds to step 506 to redetect spatial positions for persons 410-414. The process of detecting the which participant is the speaker may be repeated until the data mapping service 213 determines the confidence score is above the threshold.

At step 510, process 500 generates a mapping between the voiceprint and the spatial position of the participant. In an embodiment, the data management service 213 generates a mapping between the voiceprint and the spatial position of the participant, e.g. user 121A. The data management service 213 may store the mapping within the cache 225 for future retrieval.

At step 512, process 500 uses the voiceprint and the spatial position of the participant to identify the participant as a first active speaker. Upon identifying the first active speaker, process 500 may generate instructions to adjust the positioning of a camera so that the first active speaker is centered within a video frame produced by the camera. In an embodiment, the instruction generation service 214 generates positioning instructions for a video camera in a conference room where the active speaker is located. The instructions may be sent to the user device 101 to adjust the positioning of the camera communicatively coupled to user device 101. In other example embodiments, the voiceprint and the spatial position of the active speaker may be used to highlight the avatar of the active speaker, to provide an active speaker indicator in a list of participants, to bring the active speaker to the foreground of the videoconference feed being displayed, or to provide other indicators to distinguish the active speaker from the other participants.

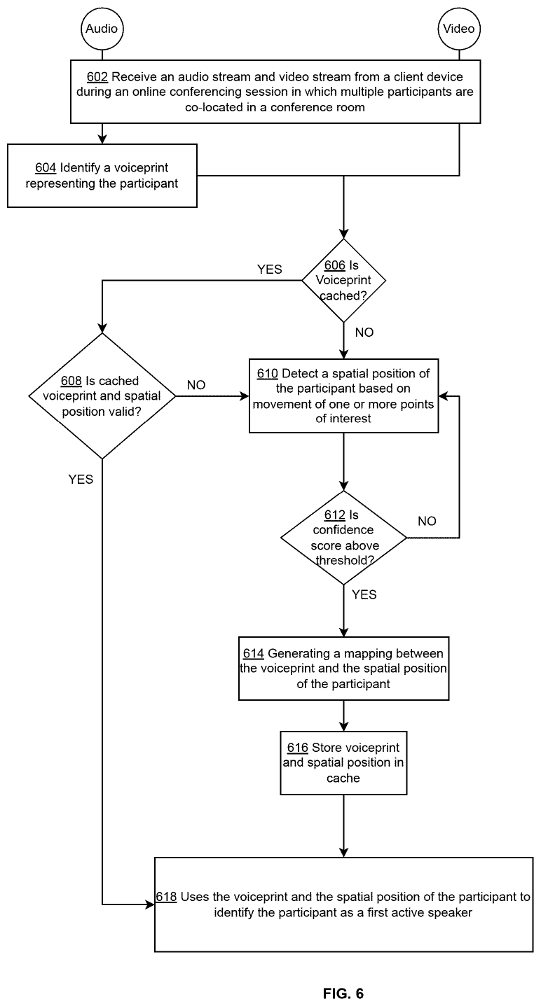

FIG. 6 depicts another flowchart for identifying an active speaker in an online group conferencing session having a plurality of co-located participants (e.g., participants in a conference room), caching spatial positioning information for speakers, and generating instructions to adjust a camera to focus on the active speaker, according to the presently described example embodiment. Process 600 may be performed by a single program or multiple programs. The steps of the process as shown in FIG. 6 may be implemented using processor-executable instructions that are stored in computer memory. For the purposes of providing a clear example, the steps of FIG. 6 are described as being performed by computer programs executing on either conferencing server 110 or user device 300. For the purposes of clarity, process 600 is described in terms of a single entity.

At step 602, process 600 receives an audio stream and a video stream from a client device during an online conferencing session in which multiple participants are co-located in a conference room. Step 602 is similar to step 502 in FIG. 5. At step 604, process 600 identifies a voiceprint representing the participant. Step 604 is similar to step 504 in FIG. 5.

At decision diamond 606, process 600 determines whether the voiceprint identified in step 604 is already cached in cache 225. If the voiceprint is already cached, then process 600 may proceed to decision diamond 608 to determine whether the cached voiceprint is still valid. In an embodiment, each of the mappings generated and stored in cache 225 also contain a timestamp for when the mapping was created. After a period of time, the voiceprint-to-spatial position mapping may become stale and not accurate. The time period for which mappings become stale may be configurable and may be based on historical data depicting how often speakers move within the conference room. If the data management service 213 determines that the voiceprint-to-spatial position mapping is not valid, then process 600 proceeds to step 610. if, however, the data management service 213 determines that the voiceprint-to-spatial position mapping is valid, then process 600 proceeds to step 618.

At step 610, process 600 detects a spatial position of the participant based on movement of one or more markers of interest of the first speaker. Step 610 is similar to step 506 in FIG. 5. At decision diamond 612, process 600 determines whether the confidence score is above a threshold. Decision diamond 612 is similar to decision diamond 508 in FIG. 5. If the data mapping service 213 determines that the confidence score for the active speaker is above the minimum threshold, then process 600 proceeds to step 614. If, however, the data mapping service 213 determines that the confidence score is below the minimum threshold, then process 600 proceeds to step 610 to redetect spatial positions. The process of detecting the active speaker may be repeated until the data mapping service 213 determines the confidence score is above the threshold.

At step 614, process 600 generates a mapping between the voiceprint and the spatial position of the participant. In an embodiment, the data management service 213 generates a mapping between the voiceprint and the spatial position of the participant, e.g. user 121A. The data management service 213 may store the mapping within the cache 225 for future retrieval. At step 616, process 600 stores the voiceprint and spatial position in the cache 225. In an embodiment, the voiceprint-to-spatial position mapping is stored in cache 225 for later use.

At step 618, process 600 uses the voiceprint and the spatial position of the participant to identify the participant as a first active speaker. Upon identifying the first active speaker, process 600 may generate instructions to adjust the positioning of a camera so that the first active speaker is centered within a video frame produced by the camera. In an embodiment, the instruction generation service 214 generates positioning instructions for a video camera in a conference room where the active speaker is located. The instructions may be sent to the user device 101 to adjust the positioning of the camera communicatively coupled to user device 101. In other example embodiments, the voiceprint and the spatial position of the active speaker may be used to highlight the avatar of the active speaker, to provide an active speaker indicator in a list of participants, to bring the active speaker to the foreground of the videoconference feed being displayed, or to provide other indicators to distinguish the active speaker from the other participants.

What is claimed is:

1. A method comprising:
receiving an audio stream and a video stream from a client device during an online conferencing session in which multiple participants are co-located in a conference room, the audio stream includes a portion of audio and the video stream includes and a set of video frames;
upon detecting a participant, of the multiple participants, speaking:
identifying, from the audio stream, a voiceprint representing the participant, wherein the voiceprint represents one or more unique vocal characteristics of the participant;
detecting, from the video stream, a spatial position of the participant based upon movement of one or more markers of interest on the participant;
generating a mapping between the voiceprint and the spatial position of the participant;
using the voiceprint and the spatial position of the participant to identify the participant as a first active speaker;
monitoring one or more mappings between voiceprints of speakers and their corresponding spatial positions;
determining whether a particular mapping of the one or more mappings is still valid;
upon determining that the particular mapping is not valid, updating the particular mapping with an updated spatial position for a particular speaker.

2. The method of claim 1, further comprising generating instructions to adjust positioning of a camera so that the first active speaker is centered within a video frame produced by the camera.

3. The method of claim 1, wherein identifying the voiceprint representing the participant comprises, using a trained machine learning model to identify the voiceprint of the participant, wherein the trained machine model is configured to receive, as input the audio stream, and identify vocal characteristics of the participant.

4. The method of claim 1, further comprising:
upon identifying the voiceprint representing the participant, generating a hash ID containing binary representations of the one or more unique vocal characteristics that make up the voiceprint.

5. The method of claim 1, wherein the one or more markers of interest on the participant comprises points on a lip of the first speaker.

6. The method of claim 1, further comprising:
upon detecting the spatial position of the participant, determining a bounding box within the video stream that contains the participant based on the spatial position.

7. The method of claim 1, wherein generating the mapping between the voiceprint and the spatial position of the participant, further comprises, storing the association between the voiceprint and the spatial position in a cache.

8. The method of claim 7, further comprising:
receiving a second audio stream and a second video stream, the second audio stream includes a second portion of audio and the second video stream includes and a second set of video frames;
upon the participant speaking:
identifying, from the second audio stream, the voiceprint representing the participant;
determining whether the voiceprint representing the participant is stored in the cache;
upon determining that the voiceprint representing the participant is stored in the cache, retrieving the mapping between the voiceprint and the spatial position of the participant;
using the mapping between the voiceprint and the spatial position of the participant, retrieved from the cache, to identify the participant as the first speaker and to generate second instructions to adjust positioning of the camera so that the first active speaker is centered within the video stream produced by the camera.

9. The method of claim 8, further comprising:
upon determining that the voiceprint representing the participant is stored in the cache,
determining whether the mapping is valid based an associated timestamp of when the mapping was generated;
upon determining that the mapping of the participant is not valid:
detecting, from the second video stream, a second spatial position of the participant based upon movement of the one or more markers of interest on the participant;
updating the mapping between the voiceprint and the second spatial position of the participant to reflect a new position of the participant.

10. A system for identifying an active speaker within an online conferencing session, comprising:
a processor; and a memory storing instructions that, when executed by the processor, cause:
receiving an audio stream and a video stream from a client device during the online conferencing session in which multiple participants are co-located in a conference room, the audio stream includes a portion of audio and the video stream includes and a set of video frames;
upon detecting a participant, of the multiple participants, speaking:
identifying, from the audio stream, a voiceprint representing the participant, wherein the voiceprint represents one or more unique vocal characteristics of the participant;
detecting, from the video stream, a spatial position of the participant based upon movement of one or more markers of interest on participant;
generating a mapping between the voiceprint and the spatial position of the participant; using the voiceprint and the spatial position of the participant to identify the participant as a first active speaker;
monitoring one or more mappings between voiceprints of speakers and their corresponding spatial positions;
determining whether a particular mapping of the one or more mappings is still valid;
upon determining that the particular mapping is not valid, updating the particular mapping with an updated spatial position for a particular speaker.

11. The system of claim 10, wherein the memory further stores instructions, comprising, generating instructions to adjust positioning of a camera so that the first active speaker is centered within a video frame produced by the camera.

12. The system of claim 10, wherein identifying the voiceprint representing the participant comprises, using a trained machine learning model to identify the voiceprint of the participant, wherein the trained machine model is configured to receive, as input the audio stream, and identify vocal characteristics of the participant.

13. The system of claim 10, wherein the memory further stores instructions, comprising:
upon identifying the voiceprint representing the participant, generating a hash ID containing binary representations of the one or more unique vocal characteristics that make up the voiceprint.

14. The system of claim 10, wherein the one or more markers of interest on the first speaker comprises points on a lip of the first speaker.

15. The system of claim 10, wherein the memory further stores instructions, comprising, upon detecting the spatial position of the participant, determining a bounding box within the video stream that contains the participant based on the spatial position.

16. A non-transitory, computer-readable medium, storing a set of instructions that, when executed by the processor, cause:
receiving an audio stream and a video stream from a client device during the online conferencing session in which multiple participants are co-located in a conference room, the audio stream includes a portion of audio and the video stream includes and a set of video frames;
upon detecting a participant, of the multiple participants, speaking:
identifying, from the audio stream, a voiceprint representing the participant, wherein the voiceprint represents one or more unique vocal characteristics of the participant;
detecting, from the video stream, a spatial position of the participant based upon movement of one or more markers of interest on participant;
generating a mapping between the voiceprint and the spatial position of the participant; using the voiceprint and the spatial position of the participant to identify the participant as a first active speaker;
monitoring one or more mappings between voiceprints of speakers and their corresponding spatial positions;
determining whether a particular mapping of the one or more mappings is still valid;
upon determining that the particular mapping is not valid, updating the particular mapping with an updated spatial position for a particular speaker.

17. The non-transitory, computer-readable medium of claim 16, wherein identifying the voiceprint representing the participant comprises, using a trained machine learning model to identify the voiceprint of the participant, wherein the trained machine model is configured to receive, as input the audio stream, and identify vocal characteristics of the participant.

18. The non-transitory, computer-readable medium of claim 16, wherein the memory further stores instructions to, upon identifying the voiceprint representing the participant, generating a hash ID containing binary representations of the one or more unique vocal characteristics that make up the voiceprint.

19. The non-transitory, computer-readable medium of claim 16, wherein the one or more markers of interest on the first speaker comprises points on a lip of the first speaker.
